(19) United States
(12) Patent Application Publication
(10) Pub. No.: US 2004/0107298 A1
(43) Pub. Date: Jun. 3, 2004

(54) Layered compression architecture for multi-hop header compression

(76) Inventor: Cedric Westphal, San Francisco, CA (US)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/640,581

(22) Filed: Aug. 14, 2003

Related U.S. Application Data
(60) Provisional application No. 60/403,820, filed on Aug. 14, 2002.

(51) Int. Cl. G06F 15/16

(52) U.S. Cl. 709/247; 709/236

(57) ABSTRACT

The use of bandwidth constrained wireless links in mobile networks necessitates the use of bandwidth saving header compression schemes. A scheme is proposed that provides an architecture for using network layer and transport layer compression efficiently based on the network. The scheme provides a distinct compression algorithm for network layer and for transport layer in headers such as the IP/TCP or IP/UDP headers. The scheme furthermore provides a layer 3 signaling for multi-link compression.

### BACKGROUND OF THE INVENTION

1. Field of the Invention

The present invention relates to a layered compression architecture for multi-hop header compression. The present invention relates in particular to a layered compression mechanism for multi-hop IP (Internet Protocol) header compression.

2. Description of the Related Prior Art

Compression of data is a commonly known way to improve data transmission rates and reduce the load for transmission networks when the data are to be sent from one network element or node to another.

In IP based networks, IP header compression is being deployed and will become more important when IPv6 phases out Ipv4 and adds to the size of the IP headers. Different schemes have been designed to achieve IP compression. Generally these schemes are only aware of a single link. Link layer information is necessary to signal IP header compression, and the compression is carried over a single link, typically one hop of wireless interface between a mobile terminal and its access router, for example.

IP header compression has traditionally focused on the compression over a resource constrained link. For instance, a mobile node (MN) communicating over the air interface to its access router (AR) would use header compression to reduce the size of the IP headers. Typical schemes would focus on the IP/UDP/RTP (Internet Protocol/User Datagram Protocol/Realtime Transport Protocol) headers (see, for example, C. Bormann, editor: “Robust Header Compression”, draft-ietf-rohc-rtp-09.txt Work in progress, IETF, February 2001) or IP/TCP (Internet Protocol/Transmission Control Protocol) headers (see, for example, V.Jacobson, R. Braden, D.Borman: “Compressing TCP/IP headers for low-speed serial links” IETF, Network working group, RFC 1144, February 1990; and Qian Zhang: “TCP/IP Header Compression for ROHC (ROHC-TCP)” draft-ietf-rohc-tcp-02.txt, IETF, work in progress).

These algorithms function by studying similarities between consecutive packets within a single flow, and eliminating these similarities once the behavior of the packets in the flow becomes predictable. The compressor sits at one end of the link and the decompressor at the other end restores the full packet header for further forwarding. These compressors function in the “time domain”, as they need several packets over time to acquire the compression state and go through a transient phase before reaping the compression benefits.

Other algorithms taking a different approach have been introduced: a user-based frequency-dependent algorithm (see, for example, C. Westphal: “Performance Analysis of User-based Header Compression Scheme” NRC Technical Report, September 2001) makes use of the correlation between the flows for a given user. A stateless algorithm (see, for example, C. Westphal, R. Koodli: “Stateless Header Compression” NRC Technical Report, September 2001) makes use of the routing information maintained by the AR in its forwarding table to compress the fields that can be aggregated. These algorithms function in a “space domain”, as they consider some address space (destination addresses for a given user, or destination prefixes for the nodes attached to a given router) for compression.

The first, traditional time-domain approach, can be construed as a vertical approach: the IP stack is compressed vertically across all the fields into the compressed header. The newer space-domain approach is a horizontal approach: the correlation is not within the fields of the same packets, but across the same field for different flows within a common group.

Current communication standards are based on an architecture called OSI model. The OSI architecture defines 7 layers: physical (layer 1), data link (layer 2), network (layer 3), transport (layer 4), session (layer 5), presentation (layer 6) and application (layer 7). The IP header replicates part of this hierarchy. It has no physical or link layer, but an IP header for network, a TCP or UDP (or RCP (Radio Control Protocol)) header for transport, and the data packets carrying the session, presentation and application layers information.

As an example, a voice session will have an IP/UDP/RTP/data format for the respective network/transport/session/application. Header compression usually happens between the layer 2 and the layer 3: network and transport information are mapped onto some link layer code at one end of the link. The code is decompressed into the original network and transport application. Usually, header compression is below layer 3, as some layer 2 information is used (for instance, to identify the source of the packets).

In mesh networks, or ad hoc networks, header compression allows to save bandwidth. However, current header compression algorithm can perform header compression only on a single link. Thus, in mesh networks in which all the hops between the mobile terminal and the Internet gateway are wireless hops, or cellular networks, in which the access router, located at the Radio Network Controller (RNC), aggregates traffic from tens of thousands of users, these compression mechanisms do not provide an optimal result. In the first case, the gain of header compression is lost beyond the first hop, but is still as necessary since the next hops still are over some air interface. In the second case, managing header compression states for a large number of users yields scalability issues.

### SUMMARY OF THE INVENTION

Thus, it is desirable to provide an improved mechanism and architecture for multi-hop header compression. In particular, it is an aim of the present invention to define an IP header compression architecture that allows header compression over several links.

This is achieved by the measures defined in the appended claims.

According to one aspect of the invention, there is proposed a method for providing IP header compression, comprising compressing network layer information using a first compression algorithm, and compressing transport layer information using a second compression algorithm.

Furthermore, according to another aspect of the invention, there is proposed a method for providing end-to-end compression in an IP network, comprising compressing network layer information using a first compression algorithm, and compressing transport layer information using a second compression algorithm, decompressing the transport layer information , and decompressing the network layer information.

Moreover, according to yet another aspect of the invention, there is proposed a system for providing IP header compression, comprising a network layer compression component associated with a first compression algorithm; and a transport layer compression component associated with a second compression algorithm.

Additionally, according to yet another aspect of the invention, a method of performing a compression/decompression of a packet data header in a packet based data communication, said method comprising a first compressing step for compressing network layer information by using a first compression algorithm in a first compressor component, and a second compressing step for compressing transport layer information by using a second compression algorithm in a second compressor component.

Furthermore, according to yet another aspect of the invention system for performing a compression/decompression of a packet data header in a packet based data communication, said system comprising a first a first compressor component for compressing network layer information by using a first compression algorithm, and a second compressor component for compressing transport layer information by using a second compression algorithm.

According to further refinements, the proposed solution may comprise one or more of the following features:

the first compression algorithm and the second compression algorithm may be processed independently;

the first compression algorithm and the second compression algorithm may be the same;

the IP header compression further may include providing signaling information;

the transport layer may be one of TCP, UDP, or RCP;

the IP header compression may occur at layer 3;

decompressing the transport layer information further may include determining whether a transport layer decompression point has sufficient resources to perform the decompression;

the first compression algorithm and the second compression algorithm may be processed independently to each other and the first compressor component and the second compressor component may be independent to each other;

the first compression algorithm may be based on a space domain architecture and the second compression algorithm may be based on a time domain architecture being orthogonal to the space domain architecture;

a first decompressing step for decompressing the network layer information in a first decompressor component and a second decompressing step for decompressing the transport layer information in a second decompressor component may be executed;

the first decompressing step and the second decompressing step may be processed independently to each other and the first decompressor component and the second decompressor component may be independent to each other;

a transmission of header compression information related to at least one of the first and the second compressing steps and a determination, by means of the header compression information, of at least one of the first and the second decompressor component may be executed;

the transmission of the header compression information may be performed by means of a layer 3 signaling;

for the layer 3 signaling an already existing signaling used for the communication may be extended or modified to provide a functionality for transmitting and processing header compression information;

when a packet is received by a destination node, a step of sending back a response message for confirming the determination of the decompressor component may be executed;

the header compression information may be transmitted in a multi-hop environment;

the compression/decompression of the packet data header may be performed on a higher level than layer 2.

According to the present invention, a compression architecture is provided which allows for IP header compression over several hops across communication networks, and potentially combines the two orthogonal “time domain” and “space domain” compression architectures. By means of this it is possible to achieve an IP header compression architecture that allows header compression over several links which is in particular advantageous when a multi-link or multi-hop header compression is required for mesh networks, for instance. Other networks may have nodes with more functionality than other (for instance, smart edge nodes, and nodes strictly focusing on efficient forwarding inside the network), and being able to compress all the way to these specific nodes is an added feature to the networks.

One point of certain embodiments of the invention is to dissociate network layer and transport layer information in the IP/transport headers. Transport header information can be compressed independently of the network header information. Furthermore, transport header information need to be managed at the packet level: the invention allows this packet level state to be managed at a convenient point in the network, which is not necessarily the first hop access router.

In particular, according to the present invention, a distinct compression algorithm for network layer and for transport layer, for example, in the IP/TCP or IP/UDP headers is provided. Furthermore, the proposed architecture is able to use network layer and transport layer compression efficiently based on the network. Additionally, according to the present invention, there is proposed a layer 3 signaling for multi-link compression is introduced in order to provide a solution for the fact that current compression schemes only use link layer signaling which limits the extend of the compression to this single link. This limitation is overcome by the proposed layer 3 signaling.

The present invention provides an improvement for header compression by allowing compression over multi-hops, by allowing end-to-end transport compression, by offering a layer 3 compression signaling and leveraging a signaling already used in connection with a communication connection, such as a QoS signaling (i.e. extending or modifying the existing signaling mechanism to provide a functionality for transmitting and processing header compression information).

The above and still further objects, features and advantages of the invention will become more apparent upon referring to the description and the accompanying drawings.

### BRIEF DESCRIPTION OF THE DRAWINGS

FIG. 1 shows an example for a network level compression architecture according to certain embodiments of the present invention.

FIG. 2 shows an example for a transport level compression architecture according to certain embodiments of the present invention.

FIGS. 3A and 3B show flowcharts illustrating a respective compression mechanism according to certain embodiments of the present invention.

### DESCRIPTION OF PREFERRED EMBODIMENTS

As described above, conventional header compression schemes operate below layer 3 since they use some layer 2 information. According to certain embodiments, an architecture is presented that is independent of the layer 2, and is only at the layer 3 and above.

Certain embodiments are directed to an approach where different layers are compressed separately. This is achieved by encoding information pertaining to the routing and forwarding of packets independently from the information relating to the transport and the application of the packet.

It could seem that there is a greater compression benefit to compress all the fields into one byte, as opposed to some fields onto one byte, and some other fields onto another byte. However, the purpose of separating the compressed fields according to different layers is as follow:

1. the absolute difference between 1 and 2 or 3 bytes is minimal compared to the compression gain. Namely, from the network point of view, the performance gain is the same if a IP/TCP header is compressed from 44 bytes to 1 or 2 bytes.

2. there are some benefits to preserving the layer separation, the main of one being that it allows for layered compression, which is described herein below.

[Layered Compression]

The purpose of a layered compression is to offer a modular compression architecture. This can be understand when contemplating the network layer and the transport layer compression architectures described below.

(Network Layer)

Network fields have a strong correlation from one flow to the next. Also, network fields are available at the network level: these are the only fields observed by the router. This entails that these are the only fields that a router —and a network domain a fortiori— on the path can conveniently keep track of, or monitor.

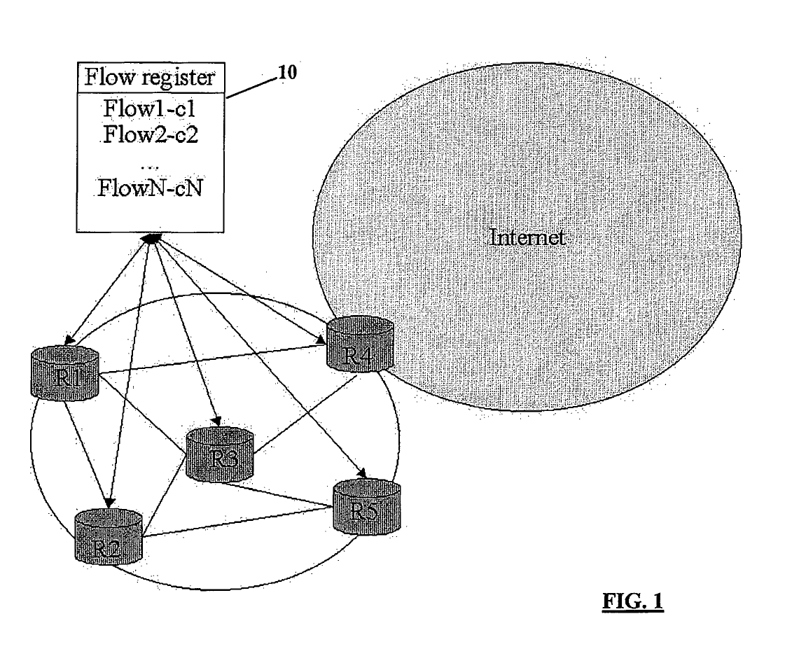

As an example, in FIG. 1, a network layer compression architecture is shown.

In FIG. 1, there is shown a plurality of routers R1-R5 forming a part of a network via which packets comprising a corresponding header are sent. At least one of these routers may be an edge router for a connection with the Internet (in FIG. 1, R4). Additionally, a flow register 10 is included in the depicted network whose functionality is described herein below. It is to be noted that as known for a person skilled in the art the shown network may further comprise several other network elements and terminals (not shown), such as mobile nodes MN and the like, which are necessary for establishing a communication connection. For the sake of simplicity these other network elements are not shown in FIG. 1 but only those parts are included necessary for understanding the network layer header compression mechanism.

In the architecture of FIG. 1, the network layer information is gathered from the flows (Flow 1-Flow N) at the router level, and send to the flow register (component) 10, that compresses the flow information into a code, or a label (cl-cN). The flow register 10 makes the labels available to the router, i.e. to each of the routers R1-R5. The labels can be used inside the network to forward the packets. When the packets are about to leave the network (e.g. at R4), the last forward can replace the label by the original uncompressed network header, which is available by the flow register 10.

This is a general case of asymmetric compression, where the compressor receives the code from an outside agent (i.e. the flow register 10), and there is an asymmetry in the information required to compute the code. In this case, only the flow register has the big picture. Another possible modification of the architecture of FIG. 1, i.e. another possible implementation of the network layer compression would be by distributing the flow register (for instance by using forwarding table at each router, or by computing flow tables at the link level to keep track of the most frequent/recent flows).

The network fields are the fields pertaining to the forwarding of the packets at the network level: these are destination, flow label, version (Ver), DS byte (Differentiated Service Byte) in IPv6, or Ver, DS byte, destination in IPv4. The state to be maintained is of the granularity of the flow, namely has to be maintained once per flow.

It is to be noted that the network fields belong to the space domain evoked earlier.

(Transport Layer)

On the other hand, transport layer fields have a strong correlation from one packet to the next within the same flow. This yields two main consequences:

the correlation can be deduced from a few consecutive packets, necessitating a transient period before compression gets effective,

a state has to be maintained at the packet granularity: state has to be updated after each packet, and so does the compression code.

When a large number of flows request header compression at the transport layer, maintaining these states can become costly. The solution to avoid large cost has been to restrict header compression to the wireless link: the number of nodes is limited by the available bandwidth and the access point's limitation. However, in some instances, such as cellular networks, the access point at the IP level is already deep into the network, connecting many base stations and tens of thousands of users.

Dissociating the network and transport layer compression gives more versatility: the decompression of the transport layer does not have to happen at the same time as the network layer. This allows to pick the place to maintain the transport layer compression states where it is convenient (for example taking into consideration sufficient resources, or the like) : for instance, at the access router, at the edge of the access network, at some header compression proxy anywhere on the data path, or at the correspondent node. Of course, nodes that must see the transport layer, such as firewalls, have to make sure that either they decompress the packets, or that the packets they see have a full IP header (and thus a full transport header. It should be noted here that modern firewalls do maintain per flow state to steer the packets on the fast path, so it is possible to maintain a compression state as well so as to understand the compressed header within the firewall.

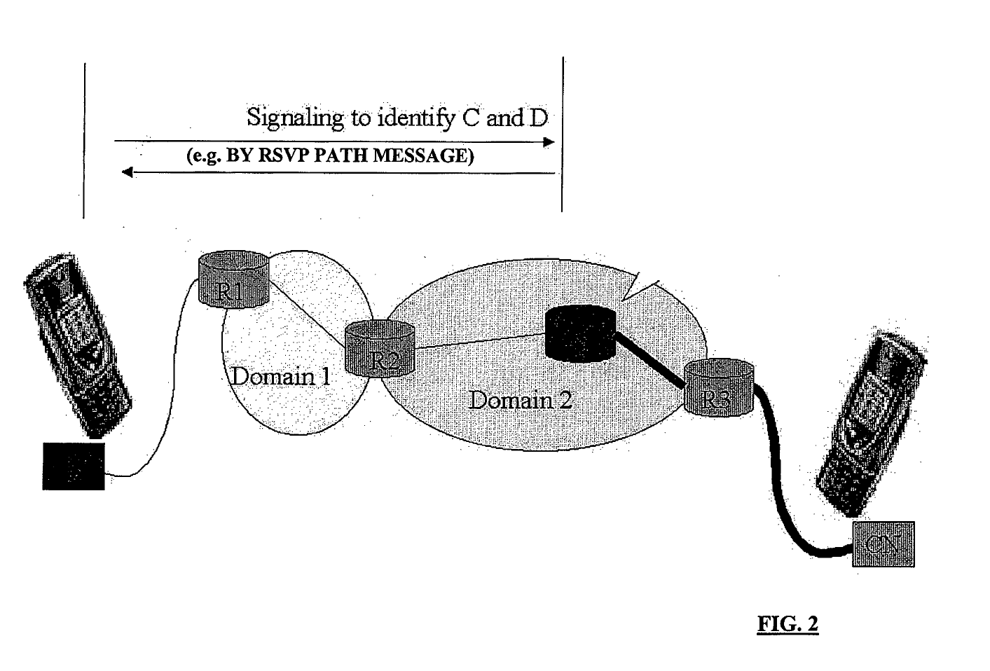

A transport level compression architecture according to certain embodiments is shown in FIG. 2. According to FIG. 2, a communication connection for sending packets is established between two mobile nodes, such as mobile terminals or the like. One of the mobile nodes, i.e. the mobile node which sends the packets, functions as a compressor (component) C, while the other mobile node is the so-called correspondent node CN. The communication connection may be established via several networks and/or domains. In the example depicted in FIG. 2, the connection is established via a router Rl belonging to a first domain 1, a router R2 being an edge between the domain 1 and a domain 2, a network element D functioning as a decompressor (component), such as a header compression proxy, and being part of domain 2, and a router R3 located at the edge of the domain 2, for example. Of course, the connection may include other network elements, domains and the like, which are omitted here for the sake of simplicity.

FIG. 2 illustrates the architecture for the transport layer compression. The packets to be transmitted from the mobile node C are processed by a compressor function in the mobile node so as to compress the packet's transport layer. The compressor and the decompressor have identified each other by way of some signaling, which is shown by the arrows between C and D and will be described later. The decompressor D can be several hops away from the compressor. In the example of FIG. 2, the correspondent node (CN) does not support header compression. On the other hand, some header compression proxy supports header compression. The decompressor D, located in the header compression proxy, restores the transport layer fields to their original values. It is to be noted that even though in FIG. 2 the decompressor functionality is located in the proxy, it is also possible that the decompressor functionality is located, for example, in R1 (or another router) or in CN.

The architecture shown in FIG. 2 allows for the deployment of a header compression proxy, which provides the header compression service to a large number of servers. Indeed, it is reasonable to expect that while some service might gain from header compression, the cost to manage state might be dissuasive, and better left of to a dedicated platform.

It is to be noted that the transport layer fields are all the fields in the header not part of the network fields.

In order to clarify the term “orthogonal” in connection with the above described transport and network layer header compression schemes, the following table 1 is given. In table 1, the differences between the different layers (i.e. transport layer and network layer) and their roles in header compression are summarized.

TABLE 1
Orthogonal layers of compression

| Transport | Network |
|---|---|
| in flow correlation | out flow correlation |
| time | space |
| end-to-end | local |
| vertical across stack | horizontal across stack |

(Header Compression Signaling)

When IP header compression is at layer 2.5, conventionally it is assisted with link layer signaling. However, for a header compression that spans several hops, the link layer information is not available anymore, and some IP signaling has to be added. In this section, it is assumed that RSVP (Resource Reservation Protocol) is used to carry header compression information. However, other signaling might be used, of course. The main point in this context is to introduce the use of layer 3 signaling to extend the reach of header compression over a multi-hop span, which represents one new aspect for the field of compression/decompression.

It might seem paradoxical to advocate signaling for header compression: adding new packets and the corresponding extra bandwidth defeats the purpose of header compression. However, this solution is advocated whenever transport header compression is not supported or is too costly locally, and some decompressor has to be found several hops away. In this case, the use of signaling enables the transport compression, and allows the overall bandwidth to be reduced. The RSVP signaling (or SIP (Session Initiated Protocol) or whatever signaling is used) is used anyway for QoS signaling: by leveraging (extending or modifying) existing signaling, there is no added bandwidth use on the network.

The signaling may be as follow:

The compressor sends a PATH (RSVP signaling message, see FIG. 2) towards the destination with a transport header compression option.

Each candidate decompressor receives the packet, and once one is willing to ensure the decompression of the packets, it writes itself into the PATH.

If for some reason, another potential decompressor feels it is more able to perform the decompression, it replaces the previous decompressor in the PATH.

If a node must see full header packets —for instance a firewall that is unable to maintain a transport compression state for this flow—, it inserts a flag so that no further downlink decompressor replaces a decompressor uplink from this node.

Another node can re-instate transport compression if it has been interrupted by setting itself as a new compressor, and changing the corresponding fields to requesting to find a second (or third, etc.) decompressor.

Once the packet is received by the destination, a RESV message is sent back to confirm to the ultimate decompressor that it has been elected, and to confirm to each compressor that a corresponding decompressor has been found.

No RSVP state is maintained once the compressor and decompressor state engines have been identified.

One application of the RSVP signaling would be to perform end-to-end or end-to-proxy header compression. For instance, the access network of a streaming audio server would gain from the header compression on his side by significantly reducing the transport bandwidth. Another example is VOIP (Voice over IP), where both entities communicating are mobile. Instead of having the headers compressed/decompressed on one side, then compressed/decompressed on the other side, this architecture allows for the transport header to be compressed across the whole end-to-end route. It is more elegant and efficient, as it reduces the overall load on the network in between.

As described above, a header compression architecture is proposed which dissociates the network from the transport compression, allowing compression to happen on different links, domains, networks. The main purpose is to offer the performance of a stateful compression while delegating the maintenance of such a compression state to either a dedicated header compression proxy, or to a convenient decompressor, be it the access router or the correspondent node. This architecture allows network fields to be compressed without any delay, improving on the performance of traditional header compression.

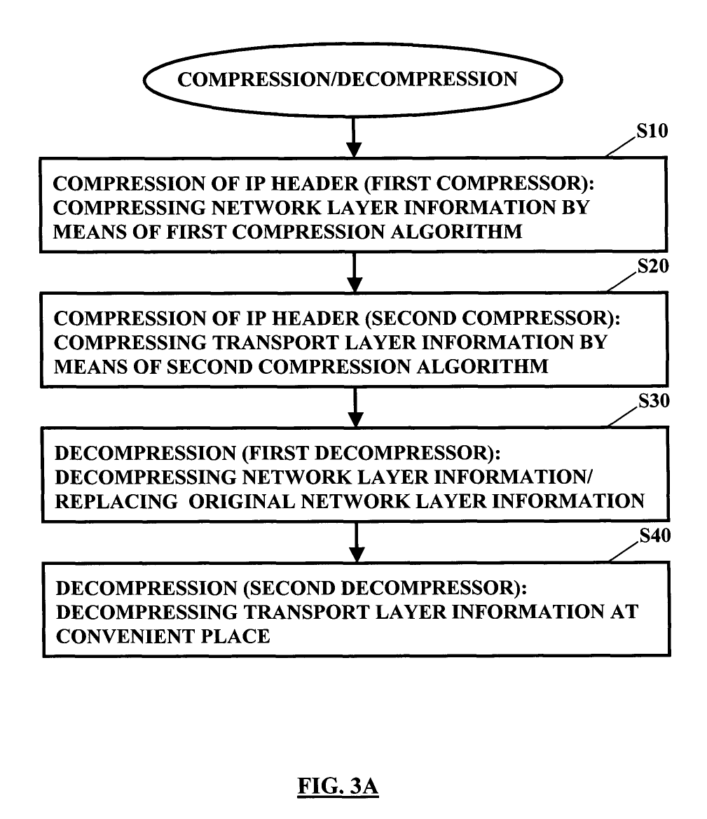

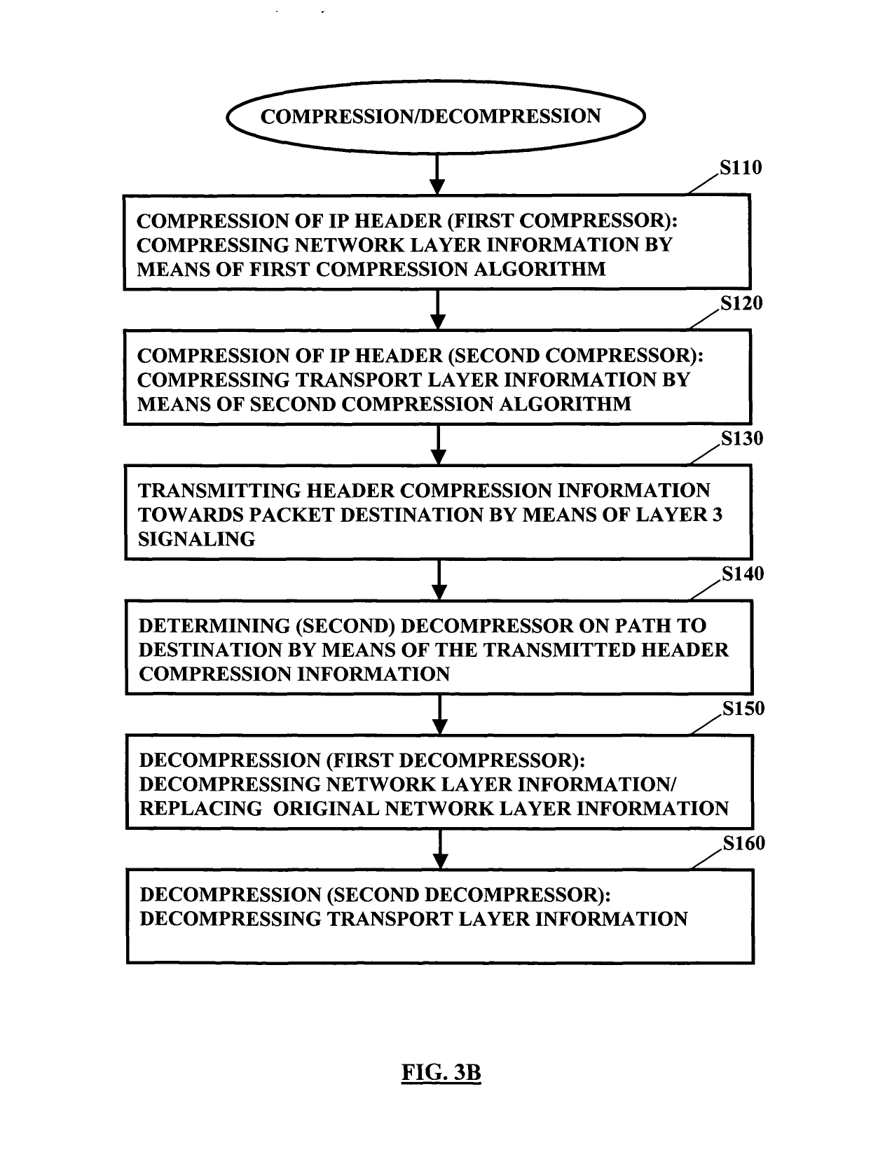

In FIGS. 3A and 3B flowcharts illustrating a respective compression/decompression mechanism according to the present invention are illustrated.

In FIG. 3A, the basic sequence of the compression/decompression of the IP header according to certain embodiments is shown.

When a packet is to be sent towards a destination, the information included in the IP header are compressed by two different steps. In step S10, as a first compressing step, network layer information of the IP header is compressed by using a first compression algorithm. This is done, for example, in a first compressor component such as the flow register 10 of FIG. 1. In step S20, as a second compressing step, transport layer information of the IP header is compressed by using a second compression algorithm. This is done, for example, in a second compressor component such as the compressor component of the mobile node (see FIG. 2). As described above, these two compressing steps (or compression architectures) are performed independently from each other. Furthermore, the first compression algorithm could be based, for example, on a space domain architecture while the second compression algorithm is based on a time domain architecture which results in an orthogonal architecture. As a further option, both compression for transport and network layer may use the same type of compression algorithm.

After the compression, when the packet reaches a convenient place in the network (see also FIG. 1), step S30 as a first decompressing step is executed for decompressing the network layer information by means of a first decompressor component (for example replacement with the original network layer information by the flow register). On the other hand, in step S40 as a second decompressing step, the transport layer information are decompressed by means of a second (conveniently chosen) decompressor component (such as the proxy of FIG. 2). As described above, the first decompressor component and the second decompressor component may be independent to each other which means that the two decompressing steps may be executed at a different time and place.

Referring to FIG. 3B, the compression/decompression according to certain embodiments in a multi-hop environment is illustrated.

Steps S110 and S120 correspond to steps S10 and S20 of FIG. 3A and are therefore not described in greater detail. In step S130, header compression information are transmitted by at least one of the first and the second compressor components (e.g. by the second compressor component) towards the destination of the packet. This transmission is preferably performed by a layer 3 signaling, such as RSVP or SIP (see FIG. 2). On the path to the destination, when receiving the header compression information carrying signaling, every receiving node may determine itself as the second decompressor component, for example (step S140).

In step S150, the original network layer information are recovered (equivalent to step S30, for example) . On the other hand, in step S160, the determined second decompressor component decompresses the transport layer information.

It is to be further noted that the above mentioned mobile nodes may also be replaced by a respective user equipment of different type. For example, the user equipment may be a mobile or fixed phone, a personal computer, a server, a mobile laptop computer, a personal digital assistant (PDA) or the like. Irrespective of its specific type, the user equipment may comprise several means (not shown) which are required for its communication functionality. Such means are for example a processor unit for executing instructions and processing data for the communication connection, memory means for storing instructions and data, for serving as a work area of the processor and the like (e.g. ROM, RAM, EEPROM, and the like), input means for inputting data and instructions by software (e.g. floppy diskette, CD-ROM, EEPROM, data interface means, and the like), user interface means for providing monitor and manipulation possibilities to a user (e.g. a screen, a keyboard, a microphone and headset for communication, and the like), and network interface means for establishing a communication connection under the control of the processor unit (e.g. wired or wireless interface means, an antenna, and the like). These means can be integrated within one device (e.g. in case of a mobile or fixed telephone) or in several devices forming the user equipment (e.g. in case of a laptop).

On the other hand, the above mentioned network elements and components, such as the routers, the proxy, the flow register and the like, may be implemented by software or by hardware. In any case, for executing their respective functions, in particular the compression/decompression function, correspondingly used devices or network elements comprise several means which are required for control and communication functionality. Such means are, for example, a processor unit for executing instructions and processing data (for example, transmission content and signaling related data), memory means for storing instructions and data, for serving as a work area of the processor and the like (e.g. ROM, RAM, EEPROM, and the like), input means for inputting data and instructions by software (e.g. floppy diskette, CD-ROM, EEPROM, and the like), user interface means for providing monitor and manipulation possibilities to a user (e.g. a screen, a keyboard and the like), and interface means for establishing a communication connection under the control of the processor unit (e.g. wired and wireless interface means, an antenna, and the like).

As described above, the use of bandwidth constrained wireless links in mobile networks necessitates the use of bandwidth saving header compression schemes. A scheme is proposed that provides an architecture for using network layer and transport layer compression efficiently based on the network. The scheme provides a distinct compression algorithm for network layer and for transport layer in headers such as the IP/TCP or IP/UDP headers. The scheme furthermore provides a layer 3 signaling for multi-link compression.

It should be understood that the above description and accompanying figures are merely intended to illustrate the present invention by way of example only. The described embodiments of the present invention may thus vary within the scope of the attached claims.

1. A method for providing IP header compression, comprising:
compressing network layer information using a first compression algorithm; and
compressing transport layer information using a second compression algorithm.

2. The method of claim 1, wherein the first compression algorithm and the second compression algorithm are processed independently.

3. The method of claim 1, wherein the first compression algorithm and the second compression algorithm are the same.

4. The method of claim 1, wherein the IP header compression further includes providing signaling information.

5. The method of claim 1, wherein the transport layer is TCP.

6. The method of claim 1, wherein the transport layer is UDP.

7. The method of claim 1, wherein the transport layer is RCP.

8. The method of claim 1, wherein the IP header compression occurs at layer 3.

9. A method for providing end-to-end compression in an IP network, comprising:
compressing network layer information using a first compression algorithm; and
compressing transport layer information using a second compression algorithm;
decompressing the transport layer information; and
decompressing the network layer information.

10. The method of claim 9, wherein decompressing the transport layer information further includes determining whether a transport layer decompression point has sufficient resources to perform the decompression.

11. A system for providing IP header compression, comprising:
a network layer compression component associated with a first compression algorithm; and
a transport layer compression component associated with a second compression algorithm.

12. The system of claim 11, wherein the network layer compression component and the transport layer compression component operate independently.

13. The system of claim 11, wherein the IP header compression occurs at layer 3.

14. The system of claim 11, wherein the IP header compression further includes providing signaling information.

15. A method of performing a compression/decompression of a packet data header in a packet based data communication, said method comprising:
a first compressing step for compressing network layer information by using a first compression algorithm in a first compressor component; and
a second compressing step for compressing transport layer information by using a second compression algorithm in a second compressor component.

16. The method of claim 15, wherein the first compression algorithm and the second compression algorithm are processed independently to each other and the first compressor component and the second compressor component are independent to each other.

17. The method of claim 15, wherein the first compression algorithm is based on a space domain architecture and the second compression algorithm is based on a time domain architecture being orthogonal to the space domain architecture.

18. The method of claim 15, further comprising:
a first decompressing step for decompressing the network layer information in a first decompressor component; and
a second decompressing step for decompressing the transport layer information in a second decompressor component.

19. The method of claim 18, wherein the first decompressing step and the second decompressing step are processed independently to each other and the first decompressor component and the second decompressor component are independent to each other.

20. The method of claim 18, further comprising steps of
transmitting header compression information related to at least one of the first and the second compressing steps and
determining, by means of the header compression information, at least one of the first and the second decompressor component.

21. The method of claim 20, wherein the step of transmitting the header compression information is performed by means of a layer 3 signaling.

22. The method of claim 21, wherein for the layer 3 signaling an already existing signaling used for the communication is extended or modified to provide a functionality for transmitting and processing header compression information.

23. The method of claim 20, further comprising, when a packet is received by a destination node, a step of sending back a response message for confirming the determination of the decompressor component.

24. The method of claim 20, wherein the header compression information is transmitted in a multi-hop environment.

25. The method of claim 15, wherein the transport layer is based on one of TCP, UDP, or RCP.

26. The method of claim 15, wherein the compression/decompression of the packet data header is performed on a higher level than layer 2.

27. A system for performing a compression/decompression of a packet data header in a packet based data communication, said system comprising:
a first a first compressor component for compressing network layer information by using a first compression algorithm; and
a second compressor component for compressing transport layer information by using a second compression algorithm.

28. The system of claim 27, wherein the first compression algorithm and the second compression algorithm are processed independently to each other and the first compressor component and the second compressor component are independent to each other.

29. The system of claim 27, wherein the first compression algorithm is based on a space domain architecture and the second compression algorithm is based on a time domain architecture being orthogonal to the space domain architecture.

30. The system of claim 27, further comprising:
a first decompressor component for decompressing the network layer information; and
a second decompressor component for decompressing the transport layer information.

31. The system of claim 30, wherein the first decompressor component and the second decompressor component are independent to each other.

32. The system of claim 30, wherein
at least one of the first or the second compressor component transmits header compression information, and
at least one of the first and the second decompressor component determines, by means of the header compression information, that it is to ensure the decompression of packets sent via the communication.

33. The system of claim 32, wherein the at least one of the first or the second compressor component transmits the header compression information by means of a layer 3 signaling.

34. The system of claim 33, wherein for the layer 3 signaling an already existing signaling used for the communication is extended or modified to provide a functionality for transmitting and processing header compression information.

35. The system of claim 32, wherein, when a packet is received by a destination node, the destination node sends back a response message for confirming the determination of the decompressor component.

36. The system of claim 32, wherein the header compression information is transmitted in a multi-hop environment.

37. The system of claim 27, wherein the transport layer is based on one of TCP, UDP, or RCP.

38. The system of claim 27, wherein the compression of packet data header is performed on a higher level than layer 2.
